(19) United States
(12) Patent Application Publication
(10) Pub. No.: US 2008/0277257 A1
(43) Pub. Date: Nov. 13, 2008

(54) KEY FOR KEYBOARD AND KEYBOARD USING THE SAME

(75) Inventors: Chia-Ching HUANG, Changhua County (TW); Yi-Shun Huang, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: Universal Scientific Industrial Co., LTD., Nan tou (TW)

(21) Appl. No.: 11/850,411

(22) Filed: Sep. 5, 2007

(30) Foreign Application Priority Data
May 8, 2007 (TW) 96207356

(51) Int. Cl. H01H 13/70

(52) U.S. Cl. 200/345

(57) ABSTRACT

A low-noise cost-effective keyboard includes keys arranged in rows and columns in a housing. Each key has a mounting member affixed to the housing, at least one button, at least one connecting member integrally connected between the mounting member and the at least one button in a manner that a top surface of the at least one button is higher in elevation than the top surface of the mounting member, and at least one stop flange protruding from a side of the button opposite to the connecting member in a manner that an end edge of the at least one stop flange is lower in elevation than a bottom surface of the button and the stop flange of one key suspends beneath one button of another key.

### BACKGROUND OF THE INVENTION

1. Field of the Invention

The present invention relates generally to keyboards, such as computer keyboards, and more particularly a special design of the keys and a keyboard using such keys.

2. Description of the Related Art

A computer keyboard is known comprising a circuit board, an elastic plate member, a bridge unit and a number of keys. The elastic plate member is mounted on the top side of the circuit board, having a plurality of compressible domes protruding upwards. The bridge unit is comprised of a plurality of bridge members (or the so-called scissors legs) that support the keys above the compressible domes. When the user clicks on the key, the clicked key is forced to compress the associated compressible dome, causing the associated compressible dome to trigger a respective switching contact of the circuit board, thereby producing a specific electrical signal.

In conventional keyboards, the keys are imprinted or marked with a sign or letter, and may have different shapes. During assembly of a keyboard, the keys must be respectively secured to the associated bridge members and then individually mounted on the compressible domes of the elastic plate member. This assembly procedure is complicated, requiring much assembly time.

Further, in order to reduce the noise during clicking of the keys, regular keyboards commonly use a membrane circuit board for producing electrical signals. However, because the keys are mounted on the bridge members, the respective bridge member is also compressed when the respective key is clicked. Each key will rub against the associated bridge member when it is clicked, thereby causing a clicking noise.

### SUMMARY OF THE INVENTION

The present invention has been accomplished under the circumstances in view. It is the primary objective of the present invention to provide a key for a keyboard, which can be directly installed in a housing of a keyboard without using a bridge unit, saving much the material cost.

It is another objective of the present invention to provide a key for a keyboard, which is a modularized design for quick installation in a keyboard, saving much the keyboard assembly time.

It is still another objective of the present invention to provide a key for a keyboard, which can lower the clicking noise during the use thereof.

To achieve the above-mentioned objectives of the present invention, the key for use in a keyboard comprises a mounting member for mounting in a housing of a keyboard, at least one button, and at least one connecting member integrally connected between the mounting member and the at least one button in a manner that a top surface of the at least one button is higher in elevation than the top surface of the mounting member. Further, at least one stop flange protrudes from a side of the button opposite to the connecting member in a manner that an end edge of the at least one stop flange is lower in elevation than a bottom surface of the button.

It is still another objective of the present invention to provide a keyboard which uses the aforesaid keys. A keyboard constructed according to the present invention comprises a housing and a plurality of aforesaid keys mounted in the housing. The keys are arranged in rows and columns in the housing with the respective mounting members affixed to the housing in such a way that the stop flange of one key suspends beneath one button of another key.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a part of a key in accordance with a preferred embodiment of the present invention;

FIG. 2 is a side view of FIG. 1;

FIG. 3 is a perspective assembly view, showing that multiple keys are assembled;

FIG. 4 is a top view of FIG. 2, showing that the buttons of the keys are arranged in rows and columns;

FIG. 5 is sectional view of a part of a keyboard using the keys according to the preferred embodiment of the present invention, showing that a plurality of keys are assembled in a housing of the keyboard with an elastic plate member and a membrane circuit board;

FIG. 6 is a top view of FIG. 5;

FIG. 7 is similar to FIG. 5, but showing that one button is clicked;

FIG. 8 is a top view of a part of an alternate arrangement of the keys of the present invention; and

FIG. 9 is a top view of a part of still another alternate arrangement of the keys of the present invention.

### DETAILED DESCRIPTION OF THE INVENTION

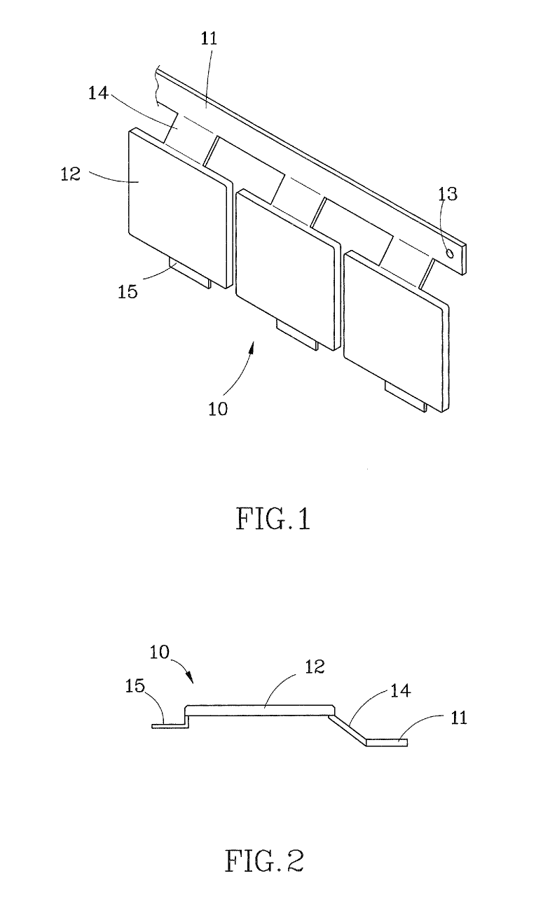

As shown in FIG. 1, a key 10 in accordance with a preferred embodiment of the present invention comprises a narrow elongated mounting member 11, a plurality of buttons 12, a plurality of connecting members 14 and a plurality of the stop flanges 15. The key 10 can be made by directly stamping a single piece of thin steel sheet or other metal material into shape. The buttons 12 are spacedly disposed at a lateral side of the mounting member 11 and arranged in a row along the length of the mounting member 11. The mounting member 11 has at least one mounting through hole 13 on each of its two distal ends for fastening to the housing of a keyboard (not shown).

Referring to FIG. 2 and FIG. 1 again, each of the connecting members 14 upwardly, obliquely and integrally extends from the lateral side of the mounting member 11 to a first side of each button 12. The connecting member 14 has a predetermined height for supporting the top surface of the associated button 12 at an elevation higher than that of the top surface of the mounting member 11. The stop flange 15 outwardly protrudes from a second side of the button 12 opposite to the first side of the button 12 in such a manner that the end edge of the stop flange 15 is lower in elevation than the bottom surface of the button 12.

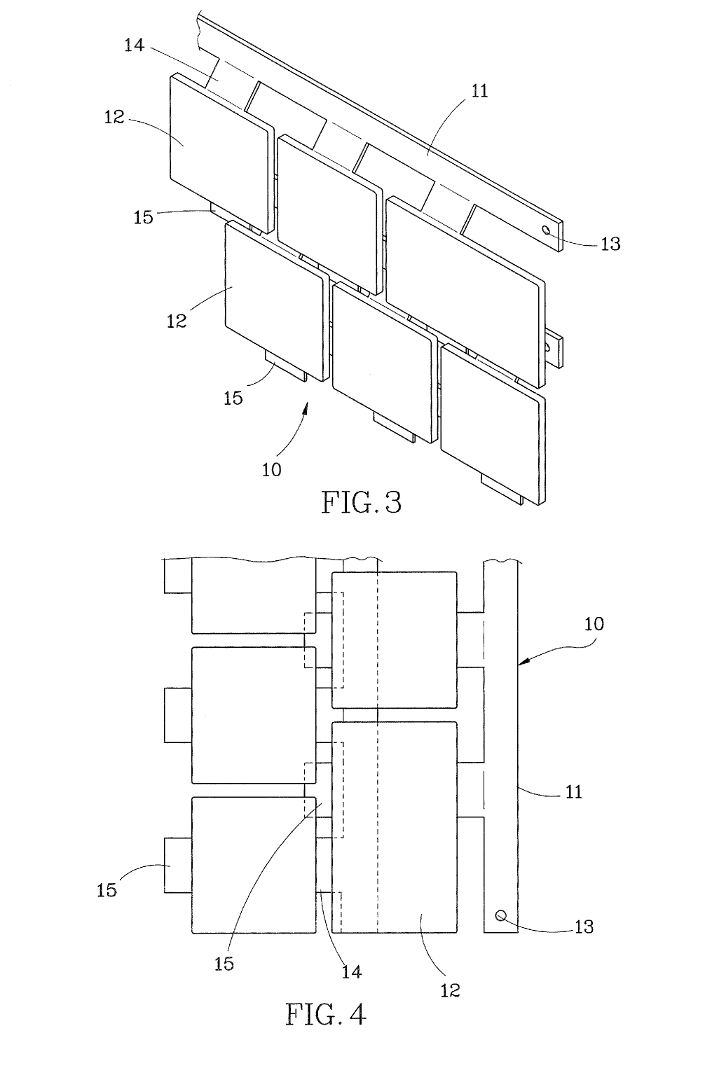

The key 10 can be used in a computer keyboard. For example, a keyboard made according to the present invention can comprise a plurality of aforesaid keys 10, an elastic plate member 20, a membrane circuit board 30, and a housing 40, as shown in FIGS. 3-6.

Referring to FIGS. 3-6, the keys 10 are arranged in rows and columns in such a way that the buttons 12 of the keys are disposed in a staggered manner along a column direction and the stop flanges 15 at a row are arranged staggeredly with respect to the connecting member 14 at next row, so that each stop flange 15 of a key 10 at a anterior row suspends below two adjacent buttons 12 at a posterior row, preventing interference among the keys 10. Further, because the stop flanges 15 of one key 10 at an anterior row suspend below the buttons 12 of the key 10 at a posterior row, the buttons 12 will not be lifted accidentally and can prevent damage of the keyboard.

The elastic plate member 12 is made of an elastic material such as rubber or silicon and provided at the bottom side of each key 10. The elastic plate member 12 includes a plurality of compressible hollow domes 22 disposed at the top side thereof and respectively stopped against the bottom sides of the buttons 12 of the keys 10. The membrane circuit board 30 is provided at the bottom side of the elastic plate member 12, having a plurality of switching contacts 31 corresponding to the compressible hollow domes 22.

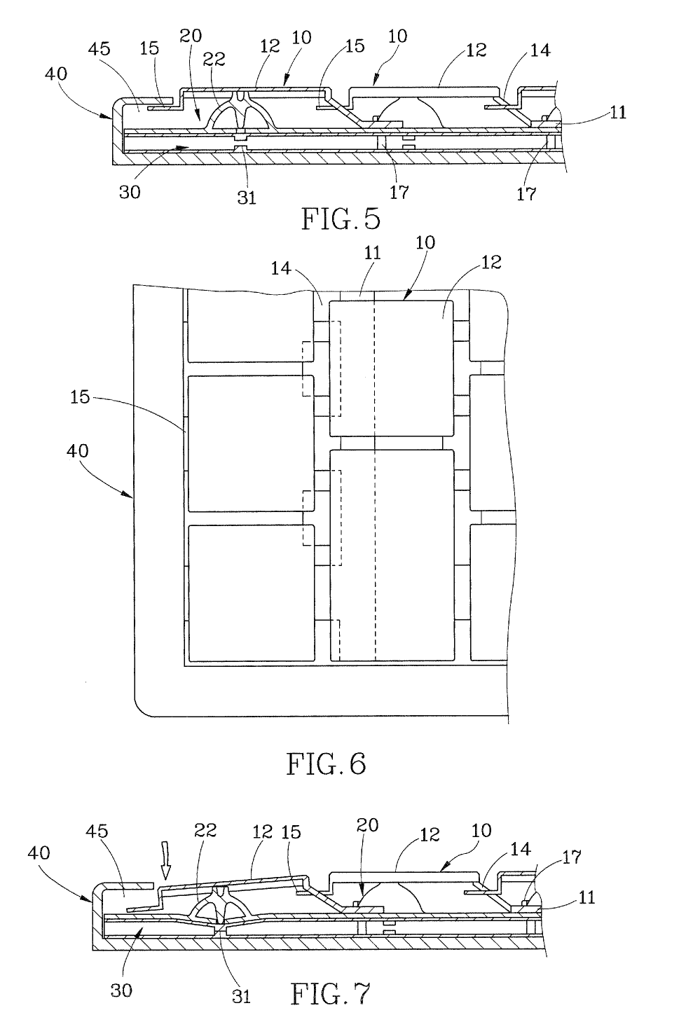

The housing 40 has an insertion slot 45, which receives the stop flanges 15 of the keys 10 at the bottommost row to prohibit lilting of the associated buttons 12 accidentally (see FIGS. 5 and 6). Further, screws 17 are installed to affix the mounting members 11 of the keys 10 to the housing 40. Of course, adhesive, plug joint, or any of a variety of other mounting devices or methods may be employed to affix the keys 10 to the housing 10. At final, the membrane circuit board 30, the elastic plate member 20, the keys 10 and the housing 10 are assembled together, forming the desired keyboard.

When the user clicks one button 12 as shown in FIG. 7, one side of the clicked button 12 uses its connecting member 14 as a support; however the stop flange 15 at the opposite side has no support. Therefore, the side of the clicked button 12 is forced to bias downward through an angle to compress the associated compressible hollow dome 22, causing the associated compressible hollow dome 22 to trigger the corresponding switching contact 31 of the membrane circuit board 30, thereby producing a specific electrical signal.

According to this embodiment, the connecting members 14 of the keys 10 have rigid and resilient characteristics and the elastic plate member 20 has an elastic characteristic, the connecting member 14 and the compressible hollow domes 22 can return the associated buttons 12 after the associated buttons 12 had been clicked.

Further, because the end edges of the stop flanges 15 suspend below the elevation of the bottom side of the buttons 12, the button 12 of one anterior key 10 that is clicked does not interfere with the stop flanges 15 of the adjacent posterior key 10, i.e., clicking the buttons 12 does not cause a linking action.

As stated above, the use of keys 10 in a keyboard eliminates the installation of a conventional bridge unit, and needs not to install every button individually. Therefore, the invention saves much installation time, and effectively reduces the manufacturing cost. Further, because the buttons 12 are respectively positively supported on the associated compressible hollow domes 22, clicking the buttons 12 does not cause noise. When one button 12 is biased downwards or returned upwards, it does not any frictional interference with the other parts. Therefore, the invention effectively reduces the noise level during operation of the keyboard.

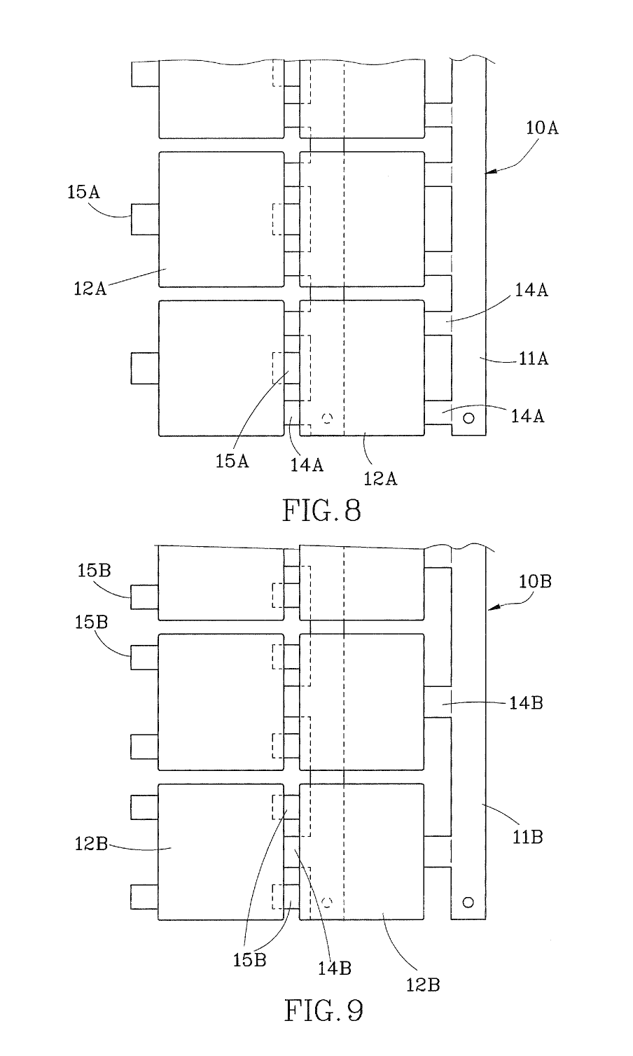

In an alternate form of the present invention as shown in FIG. 8, the keys 10A are arranged in rows and columns in such a way that the buttons 12A are aligned in line both in the row direction and the column direction. According to this embodiment, two connecting members 14A are connected between each button 12A and the associated mounting member 11A. The two connecting members 14A of each button 12A are spaced from each other at a certain distance so that the stop flange 15A of one button 12A of one key 10A at a row suspends in the space between the two connecting members 14A of one button 12A of the key 10A at a next row. In another alternate form of the present invention as shown in FIG. 9, each button 12B at a row has two stop flanges 15B suspending below the button 12B at a next row at two sides of the connecting member 14B of the button 12B at a next row. The alternative forms of the connecting members 14A and 14B and the stop flanges 15A and 15B prevent lifting of the buttons 12A and 12B accidentally.

Further, screws 17 may be fastened to the mounting member 11 of each key 10 corresponding to the respective connecting members 14 to affix the keys 10 to the housing 40, enhancing the firmness of the buttons 12 in operation.

Further, when only one single key 10 is installed, the stop flanges 15 of the key 10 can be received in the insertion slot 45 of the housing 40. When one single key 10 contains only one button 12, the stop flange(s) 15 of the key 10 can be received in the insertion slot 45 of the housing 40, i.e., the protective design of the stop flanges 15 of the keys 10 is applicable to the installation of multiple keys or one single key.

Further, the keys 10 can be molded from light transmissive plastics, for example, polyethylene. During installation, a light emitting device (not shown) is provided below each key 10 to constitute a backlight keyboard. The light emitting device can be, for example, an LED (light emitting diode).

Further, the connecting members 14 of the keys 10 may be variously shaped subject to the keyboard installation requirements. For example, the connecting members 14 can be slotted to enhance their elastic force. Therefore, the connecting members 14 of the aforesaid various different forms of the present invention are not a limitation.

In conclusion, the invention has the following features and advantages:

1. By means of the respective mounting member 11, each key 10 is directly fastened to the housing 10 without any bridge devices, saving much the material cost.

2. The keys 10 are an elongated member containing one or more buttons 12 for modularized installation, saving much keyboard assembly time.

3. The structural design of the keys 10 prevents friction of the buttons 12 with the other parts when the buttons 12 are clicked, lowering the clicking noise during the operation of the keyboard.

4. The keys 10 can be matched with light emitting devices, forming a backlight keyboard structure.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A key For a keyboard, the key comprising:
a mounting member having a top surface;
at least one button having a top surface;
at least one connecting member integrally connected between the mounting member and the at least one button in a manner that the top surface of the at button is higher in elevation than the top surface of the mounting member; and
at least one stop flange protruding from a side of the button opposite to the connecting member;
wherein the at least one stop flange has an end edge lower in elevation than a bottom surface of the button.

2. The key as claimed in claim 1, wherein the at least one connecting member upwards and obliquely extends from the mounting member to the at least one button.

3. (canceled)

4. The key as claimed in claim 1 which is made by stamping a single piece of metal sheet member.

5. The key as claimed in claim 1 which is integrally molded from a plastic material.

6. The key as claimed in claim 5 which is light transmissible.

7. A keyboard comprising:
a housing; and
a plurality of keys each of which comprises:
a mounting member mounted in the housing and having a top surface;
at least one button having a top surface, a first side and a second side opposite to the first side;
at least one connecting member integrally connected between the mounting member and the first side of the at least one button in a manner that the top surface of each of the at least one button is higher in elevation than the top surface of the mounting member; and
top surface of each of the at least one stop flange is lower in elevation than a bottom surface of each of the at least one button;
wherein the keys are arranged in rows and columns in the housing in a manner that the at least one stop flange of one button of the key suspends beneath one button of another one of the keys.

8. The keyboard as claimed in claim 7, wherein the buttons of the keys are staggeredly arranged in rows and columns.

9. The keyboard as claimed in wherein the housing has an insertion slot for receiving the at least one stop flange of one of the keys.

10. The keyboard as claimed in claim 7, further comprising an elastic plate member mounted in the housing and provided with a plurality of compressible domes located below the buttons of the respectively.

11. The keyboard as claimed in claim 7, further comprising a membrane circuit disposed in the housing.

12. The keyboard as claimed in claim 7, further comprising a light emitting device mounted in the housing.

13. The keyboard as claimed in claim 7, wherein the at least one connecting member upwards and obliquely extends from the mounting member to the at least one button.

14. The keyboard as claimed in claim 7, wherein the keys are respectively made by stamping a single piece metal sheet member.

15. The keyboard as claimed in claim 7, wherein the keys are integrally respectively molded from a plastic material.

16. The keyboard as claimed in claim 15, wherein the keys are light transmissible.
